(19) United States
(12) Patent Application Publication
(10) Pub. No.: US 2025/0384593 A1
(43) Pub. Date: Dec. 18, 2025

(54) ENCODING AND DECODING POINT DATA IDENTIFYING A PLURALITY OF POINTS IN A THREE-DIMENSIONAL SPACE

(71) Applicant: Telefonaktiebolaget LM Ericsson (publ), Stockholm (SE)

(72) Inventors: Niclas SVENSSON, Stockholm (SE); Volodya GRANCHAROV, Solna (SE)

(73) Assignee: Telefonaktiebolaget LM Ericsson (publ), Stockholm (SE)

(21) Appl. No.: 18/878,168

(22) PCT Filed: Jun. 27, 2022
(86) PCT No.: PCT/EP2022/067615

§ 371 Date: Dec. 23, 2024

(51) Int. Cl. G06T 9/40; G06T 15/20

(52) U.S. Cl. CPC G06T 9/40; G06T 15/205; G06T 2210/56

(57) ABSTRACT

A method (900) of encoding point data identifying a set of points in a three-dimensional (3D) space (3D points) is provided. The set of 3D points correspond to a set of physical points of a real-world environment. The method comprises dividing (s902) the set of 3D points into a first subset of 3D points and a second subset of 3D points, encoding (s904) first 3D point data identifying the first subset of 3D points using a first compression scheme, thereby generating first encoded point data, and encoding (s906) second 3D point data identifying the second subset of 3D points using a second compression scheme, thereby generating second encoded point data. The first compression scheme and the second compression scheme are different.

### TECHNICAL FIELD

Disclosed are embodiments related to methods and apparatus for encoding and/or decoding point data identifying a plurality of points in a three-dimensional (3D) space (3D points) corresponding to a plurality of real-world points.

### BACKGROUND

Today 3D reconstruction of a space is widely used in various fields. For example, for home renovation, one or more cameras capable of capturing a 360-degree view may be used to capture multiple shots of a kitchen that is to be renovated, and the kitchen may be reconstructed in a 3D virtual space using the captured multiple images. The generated 3D reconstruction of the kitchen can be displayed on a screen and manipulated by a user in order to help the user to visualize how to renovate the kitchen. In 3D virtual space, there are a plurality of 3D points identifying an object or a structure of the 3D virtual space. In this disclosure, the plurality of 3D points is also referred as a point cloud.

A point cloud is an unstructured set of K points in a 3D space. As discussed above, the points are used to capture the scene geometry and scale, i.e., to represent 3D structures, of a real-world environment. The point cloud may also store additional information about the 3D points. This additional information is called attributes. Typical attributes are color information, reflectance, normal vectors, etc. A 3D point may be expressed as (Xₖ, Yₖ, Zₖ)ₖ₌₁^{K}.

Depending on the application and the type of scanning devices used for capturing a view of the real-world environment, the acquired 3D point clouds can have very different statistics. For example, dense 360° LiDAR point clouds may be obtained by using scanning devices like Leica BLK360, which are positioned on a tripod at different positions on the floor. At each position, they spin around and perform 360° scan of the physical environment. These point clouds are collected in order to create accurate 3D map of the real-world environment, e.g., “digital twin,” which can be used in various industrial applications.

These point clouds are much denser than the point clouds generated by an autonomous vehicle, and individual 360° scans do not have to be processed individually in close to real-time scenario. A complete 3D map can be created in an offline manner by connecting the individual 360° scans. The already registered (stitched together) N point clouds from individual 360° scans may be expressed as:

$${Ω}_{1} = {( {X}_{{k}_{1}} , {Y}_{{k}_{1}} , {Z}_{{k}_{1}} )}_{{k}_{1} = 1}^{{K}_{1}} , … , {Ω}_{N} = {( {X}_{{k}_{N}} , {Y}_{{k}_{N}} , {Z}_{{k}_{N}} )}_{{k}_{N} = 1}^{{K}_{N}}$$

$$K = {\sum }_{n = 1}^{N} {K}_{n}$$

where Ωₙ is a point cloud obtained at location n, Xkₙ is a set of X coordinates of the 3D points included in the point cloud, Ykₙ is a set of Y coordinates of the 3D points included in the point cloud, and Zkₙ is a set of Z coordinates of the 3D points included in the point cloud. Kₙ is the total number of 3D pints included in each point cloud, and K is the total number of 3D points included in a set of point clouds.

The point data of the point clouds are typically kept together in E57 format. Also a set of scanning device poses P₁ . . . P_{N} corresponding to the point clouds may be stored with the point data of the point clouds. Ψ={P₁, Ω₁, . . . , P_{N}, Ω_{N}}.

This allows easy access to each of the individual point clouds, as well to a “fused” point cloud (union of all individual scans) that define a complete 3D map of the visual scene.

$${Ω}_{Ψ} = {Ω}_{1} ⋃ {Ω}_{2} ⋃ … ⋃ {Ω}_{N}$$

### SUMMARY

However, certain challenges exist. Typical size of dense LiDAR point clouds ranges from 1 GB to several GBs. Thus, storing such point clouds requires a huge amount of space in a storage medium and transmitting such point clouds requires a substantial amount of signal bandwidth. Therefore, there is a need for efficiently compressing and decompressing the point data identifying the plurality of 3D points.

Accordingly, in one aspect of some embodiments of this disclosure, there is provided a method of encoding point data identifying a set of three-dimensional (3D) points, the set of 3D points corresponding to a set of physical points of a real-world environment. The method comprises: dividing the set of 3D points into a first subset of 3D points and a second subset of 3D points; encoding first 3D point data identifying the first subset of 3D points using a first compression scheme, thereby generating first encoded point data; and encoding second 3D point data identifying the second subset of 3D points using a second compression scheme, thereby generating second encoded point data. The first compression scheme and the second compression scheme are different.

In a different aspect, there is provided a method of decoding encoded point data identifying a set of three-dimensional (3D) points, the set of 3D points corresponding to a set of physical points of a real-world environment. The method comprises: obtaining the encoded point data comprising first encoded point data and second encoded point data, wherein the first encoded point data identifies a first subset of 3D points and the second encoded point data identifies a second subset of 3D points, and decoding the first encoded point data using a first decompression scheme, thereby generating first decoded point data. The method further comprises decoding the second encoded point data using a second decompression scheme, thereby generating second decoded point data. The first compression scheme and the second compression scheme are different.

In a different aspect, there is provided a computer program comprising instructions (1144) which when executed by processing circuitry cause the processing circuitry to perform the method of any one of the embodiments described above.

In a different aspect, there is provided an apparatus for encoding point data identifying a set of three-dimensional (3D) points, the set of 3D points corresponding to a set of physical points of a real-world environment. The apparatus is configured to divide the set of 3D points into a first subset of 3D points and a second subset of 3D points; encode first 3D point data identifying the first subset of 3D points using a first compression scheme, thereby generating first encoded point data; and encode second 3D point data identifying the second subset of 3D points using a second compression scheme, thereby generating second encoded point data. The first compression scheme and the second compression scheme are different.

In a different aspect, there is provided an apparatus for decoding encoded point data identifying a set of three-dimensional (3D) points, the set of 3D points corresponding to a set of physical points of a real-world environment. The apparatus is configured to: obtain the encoded point data comprising first encoded point data and second encoded point data, wherein the first encoded point data identifies a first subset of 3D points and the second encoded point data identifies a second subset of 3D points; decode the first encoded point data using a first decompression scheme, thereby generating first decoded point data; and decode the second encoded point data using a second decompression scheme, thereby generating second decoded point data. The first compression scheme and the second compression scheme are different.

In a different aspect, there is provided an apparatus. The apparatus comprises a memory; and processing circuitry coupled to the memory. The apparatus is configured to perform the method of any one of the embodiments described above.

Embodiments of this disclosure improve compression efficiency by selecting the optimal compression scheme for a given multi sweep 3D point cloud in the structure Ψ.

The accompanying drawings, which are incorporated herein and form part of the specification, illustrate various embodiments.

### BRIEF DESCRIPTION OF THE DRAWINGS

FIG. 1 shows an exemplary scenario where embodiments of this disclosure are implemented.

FIG. 2A shows an exemplary apparatus according to some embodiments.

FIG. 2B shows an exemplary view within the apparatus shown in FIG. 2A.

FIG. 3A shows an encoder according to some embodiments.

FIG. 3B shows a decoder according to some embodiments.

FIGS. 4A and 4B illustrate a compression scheme according to some embodiments.

FIGS. 5A and 5B illustrate a compression scheme according to some embodiments.

FIG. 6 shows a process according to some embodiments.

FIGS. 7A-7C illustrate a compression scheme according to some embodiments.

FIGS. 8A-8C illustrate overlap between neighboring point clouds.

FIG. 9 shows a process according to some embodiments.

FIG. 10 shows a process according to some embodiments.

FIG. 11 shows an apparatus according to some embodiments.

### DETAILED DESCRIPTION

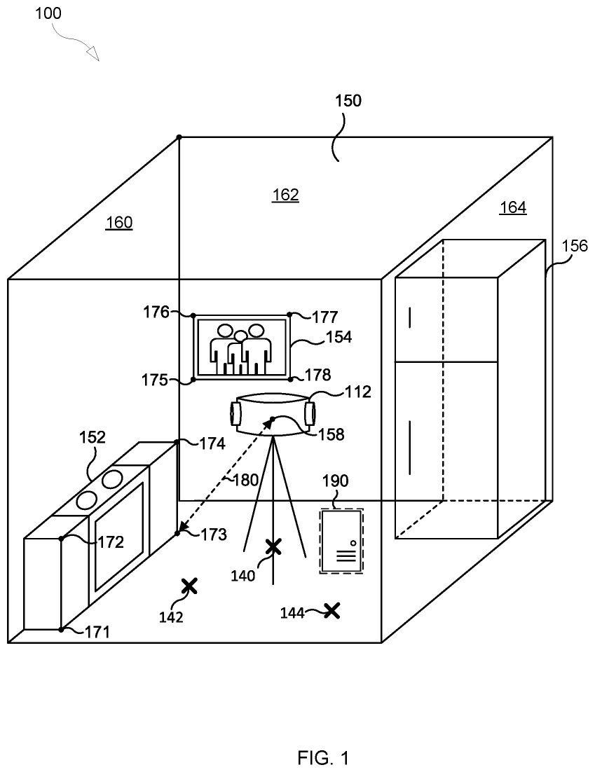

FIG. 1 shows an exemplary scenario 100 where embodiments of this disclosure are implemented. In scenario 100, a capturing device 112 is used to capture a view of a kitchen 150 at each of different locations (e.g., 140, 142, and 144). In kitchen 150, an oven 152, a picture frame 154, and a refrigerator 156 are located. As shown in FIG. 1, oven 152 is placed against a first wall 160, picture frame 154 is placed against a second wall 162, and refrigerator 156 is placed against second wall 162 and a third wall 164.

Capturing device 112 includes a camera and a Light Detection and Ranging (LiDAR) sensor. The camera is configured to capture a view of kitchen 150. One example of the camera is a 360-degree camera—a camera that is capable of capturing a 360-degree view of a real-world environment.

The LiDAR sensor is configured to collect depth values of various real-world points (e.g., points 171-178) of kitchen 150. Here, a depth value of a particular real-world point indicates a distance between a view point 158 of capturing device 112 and the particular real-world point. For example, a depth value of a real-world point 173 indicates a distance 180 between point 173 and view point 158. One example of view point 158 is a center point of the camera.

Once the view of kitchen 150 is captured by the camera and depth values of the real-world points included in the view of kitchen 150 are measured by the LiDAR sensor, capturing device 112 may transmit the captured/measured data to a computing device 190 which is connected to capturing device 112 (wirelessly or via a wired connection). After receiving the data, computing device 190 may combine the data collected by the camera and the data collected by the LiDAR sensor, thereby generating point data identifying a plurality of a three-dimensional (3D) points.

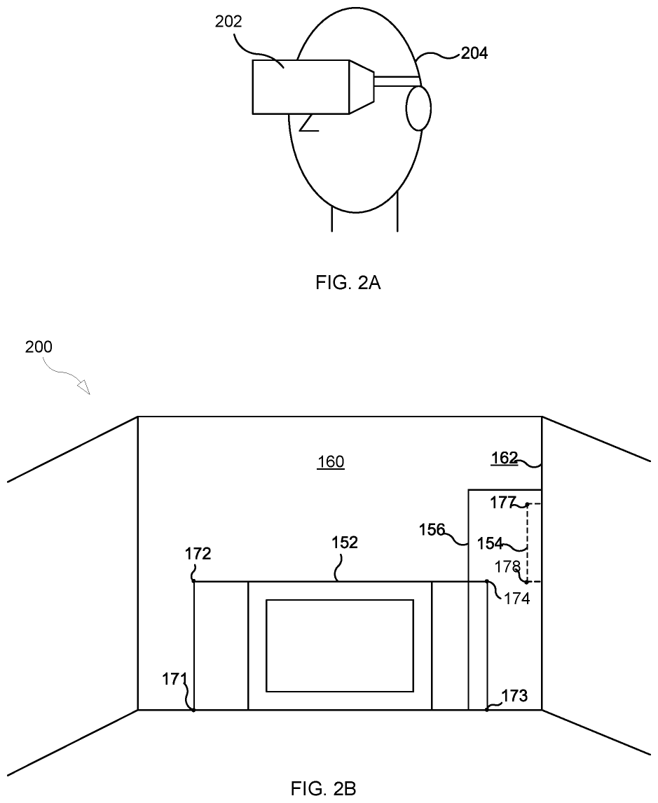

In some embodiments, the point data identifying the 3D points may be used to reconstruct the real-world environment captured by capturing device 112. For example, the point data identifying the 3D points may be used to generate an extended-reality (XR) (including a virtual-reality, a mixed-reality, or an augmented-reality) scene using an XR display 202 shown in FIG. 2A. View 200 shown in FIG. 2B is an example of the view user 204 sees via XR display 202. The point data of each 3D point may include a 3D coordinate of the 3D point and/or color/luminance values of the 3D point.

The point data identifying the plurality of 3D points generated by computing device 190 may be stored in a storage (e.g., included in computing device 190). However, as discussed above, typical size of the point data ranges from 1 GB to several GBs, and thus storing the point data would require a substantial amount of storage space.

Additionally, in some scenarios, there is a need to send the point data of the 3D points from one entity to another entity. For example, assume that an owner of a house wants to renovate kitchen 150 but a desired kitchen designer is located far from the house. In such case, once a view of kitchen 150 is captured and the point data identifying the 3D points of kitchen 150 is generated by computing device 190, the point data needs to be sent from computing device 190 to XR display device 202 such that the kitchen designer can see the reconstructed 3D view of kitchen 150. However, due to the large size of point data, transmitting the point data would consume a substantial amount of data bandwidth. Therefore, there is a need for efficiently compressing and decompressing the point data identifying the plurality of 3D points.

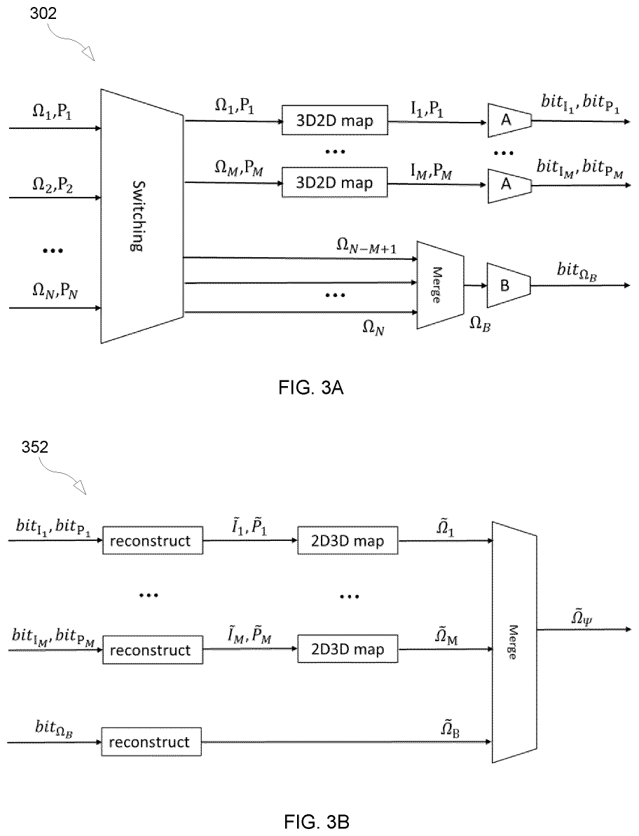

FIG. 3A shows an encoder 302 and FIG. 3B shows a decoder 352, according to some embodiments. Encoder 302 is configured to selectively apply a first compression scheme (a.k.a., “compression scheme type A” or “CST A”) and a second compression scheme (a.k.a., “compression scheme type B” or “CST B”) to point data corresponding to a different group of 3D points, thereby generating encoded point data.

More specifically, encoder 302 is configured to encode M point clouds from a set of N point clouds one by one by converting them into 2D range images (CST A) and encode the remaining point clouds (N-M point clouds) by fusing them first and then encoding them into the fused point clouds (CST B). In some embodiments, camera poses (i.e., a direction of the camera used for capturing an image) for M point clouds P₁, . . . , P_{M} may also be compressed and transmitted as the decoder needs this information to generate individual sweep point clouds Ω₁ . . . Ω_{M} from the reconstructed range images I₁ . . . I_{M}.

Decoder 352 is configured to selectively apply a first decompression scheme and a second decompression scheme to encoded point data corresponding to a different group of 3D points. Once decoder 352 receives a bitstream from encoder 302, decoder 352 may be configured to reconstruct point cloud \tilde{Ω}_{B} compressed using CST B directly. For the point data compressed using CST A, decoder 352 may be configured to reconstruct range images and poses from the bitstream first, and then generate point cloud corresponding to individual sweeps based on the reconstructed range images and poses. Lastly, decoder 352 may be configured to fuse all point clouds, thereby generating a complete point cloud \tilde{Ω}_{Ψ}. In some embodiments, each of the bitstreams decoder 352 receives or obtains may include a value indicating whether the encoded point data included in the bitstream is encoded using CST A or CST B. Thus, such value indirectly indicates to decoder 352 whether to apply a decompression scheme according to CST A or CST B.

One of the reasons of selectively applying different compression schemes to different groups of 3D points is as follows.

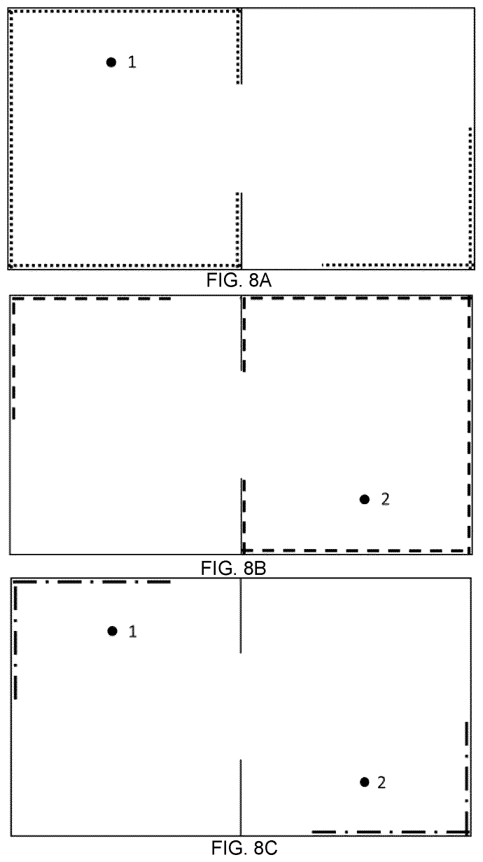

In the scanning process, there is generally significant overlap between point clouds scanned at neighboring scanned positions. However, as shown in FIGS. 8A-8C, due to occlusions, the overlap between neighboring point clouds can be significantly reduced. FIGS. 8A-8C show top-down views (floor plan style) of area scanned from two positions 1 and 2. FIG. 8A shows illustrates a scanner at position 1 and locations of point cloud (the dotted line) obtained from the scanner at position 1. FIG. 8B illustrates a scanner at position 2 and locations of point cloud (the dotted line) obtained from the scanner at position 2. FIG. 8C shows the overlapped locations of the points clouds from FIGS. 8A and 8B.

When the overlap between the neighboring point clouds is reduced, the potential gain of coding them as a joint 3D structure (over individually coding them as 2D structures) decreases. At the extreme, if the entire set of point clouds Ψ consists of non-overlapping point clouds, coding the point clouds as 2D panoramic range images is the best option. On the other hand, if Ψ consists of heavily overlapping point clouds, compressing them as a fused 3D structure is the best option. Selectively applying different compression schemes to different groups of 3D points enables searching for the optimal partitioning such that overlapping point clouds are coded together while remote (or behind the corner scans) are coded separately.

As discussed above, capturing device 112 may be configured to capture a view of kitchen 150 at N number of different locations (i.e., performing N sweepings). At each location, capturing device 112 and computing device 190 may identify a plurality of 3D points and generate point data corresponding to the identified plurality of 3D points. In this disclosure, the plurality of 3D points for each capturing location (140, 142, or 144) is referred as a “point cloud.”

Thus, if the view of kitchen 150 is captured at N different locations, there will be N point clouds (Ω₁, Ω₂, . . . , Ω_{N}). One point cloud (Ω₁) corresponds to capturing location 140 while another point cloud (Ω₂) corresponds to capturing location 142.

As shown in FIG. 3A, encoder 302 is configured to split the N point clouds (Ω₁, Ω₂, . . . , Ω_{N}) obtained from individual sweeps into two groups—the first group (Ω₁, Ω₂, . . . , Ω_{M}) and second group (Ω_{M+1}, Ω₂, . . . , Ω_{N}). The point clouds in the first group may be encoded one-by-one using CST A while the point clouds in the second group (Ω_{B}=Ω_{N-M+1}∪ . . . ∪Ω_{N}) are fused and encoded using CST B.

As shown in FIG. 3B, decoder 352 is configured to receive the encoded point data for the 3D points in the first group and the encoded point data for the 3D points in the second group. Upon receiving the encoded point data, decoder 352 is configured to generate the set of single sweep point clous {\tilde{Ω}₁, . . . , \tilde{Ω}_{M}} with the help of reconstructed range images {Ĩ₁, . . . , Ĩ_{M}} and reconstructed sensor poses {\tilde{P}₁, . . . , \tilde{P}_{M}}. These single sweep point clouds are merged with the reconstructed \tilde{Ω}_{B}, to generate the complete point cloud:

$${\tilde{Ω}}_{Ψ} = {\tilde{Ω}}_{1} ⋃ … ⋃ {\tilde{Ω}}_{M} ⋃ {\tilde{Ω}}_{B}$$

### 1. CST A

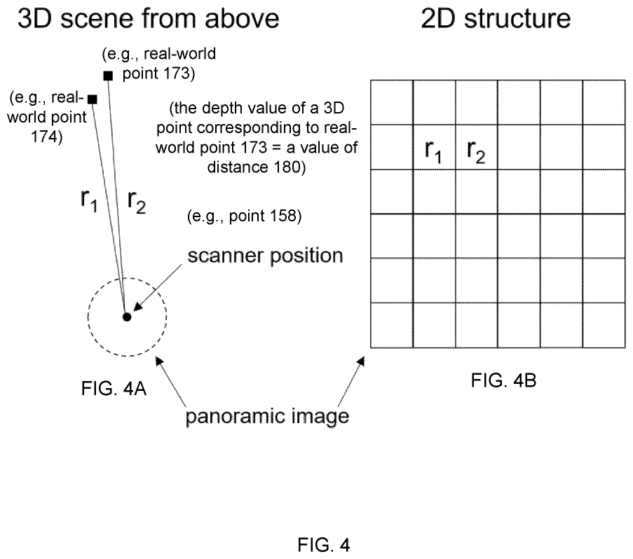

As discussed above, the LiDAR sensor included in capturing device 112 is configured to measure a depth value of a 3D point, which indicates a real-world distance between a real-world point corresponding to the 3D point and a position of the LiDAR sensor. For example, in FIGS. 1 and 4A, a value of distance 180 between a position of the LiDAR sensor (e.g., view point 158 of the camera) and real-world point 173 is a depth value of a 3D point corresponding to real-world point 173. Even though, in FIG. 1, the position of the LiDAR sensor is set to be same as view point 158 of the camera, in other embodiments, the position of the LiDAR sensor may be located somewhere else.

Due to the nature of the capturing with the rotating LiDAR sensor, 3D points in a single sweep point cloud (Ω₁) in spherical (r,θ,φ) or cylindrical coordinates (r,θ,z) can be seen as lying on a surface. Thus, in CST A, the depth values of the 3D points are projected onto a 2D plane (x, y), thereby generating a panoramic range image shown in FIG. 4B (e.g., mapping a full 360° point cloud to a single panorama image).

One way of generating this panoramic range image is by converting the images captured by the camera included in capturing device 112 into equirectangular images in which the longitude and the latitude of a 3D point is mapped to horizontal and vertical coordinates. The resulting panoramic images with depth values (a.k.a., range values) may be efficiently encoded by splitting them into occupancy and range planes.

### 2. CST B

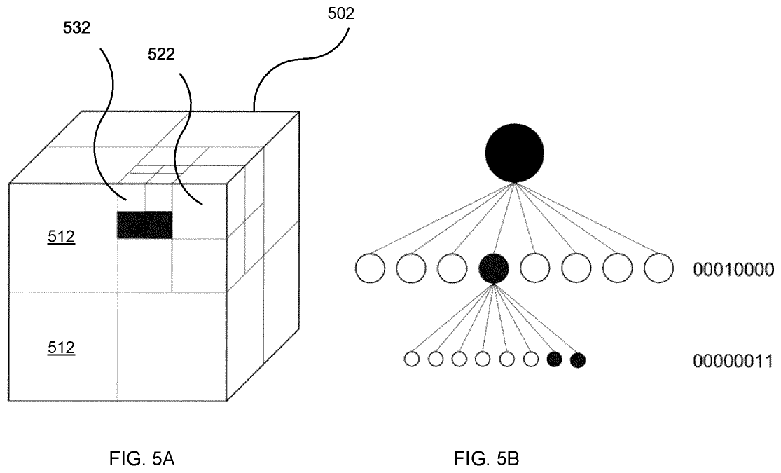

In CST B, instead of projecting the point clouds onto a 2D surface, an octree coding is used to compress the point data of the point clouds. More specifically, as shown in FIG. 5A, in CST B, a coordinate of each 3D point included in the point clouds is quantized into an integer coordinate, and placed within a volume 502 (e.g., a cube) having the dimension of D×D×D. The volume may be segmented into 8 sub-cubes 512 having the dimension of D/2×D/2×D/2.

If a sub-cube 512 contains at least one 3D point, then sub-cube 512 is segmented into 8 smaller sub-cubes 522 having the dimension of D/4×D/4×D/4. Then if smaller sub-cube 522 contains at least one 3D point, then smaller sub-cube 522 may be segmented into 8 micro sub-cubes 532. This segmentation process can be repeated until a sub-cube of a predetermined size (e.g., D/16×D/16×D/16) containing the 3D point can be identified. On the other hand, if a sub-cube does not contain any 3D points, the segmentation process for this sub-cube branch may end.

The above process generates a tree structure (an octree) (shown in FIG. 5B) where each node can be represented using 8 bits and each bit indicates the occupancy status of one sub-cube. For example, the 8 bits 00010000 may indicate that a fourth sub-cube 512 contains a 3D point data, and the 8 bits 00000011 may indicate that each of seventh and eighth smaller sub-cubes 522 contains a 3D point.

For lossy compression, the octree may be coded as a pre-determined level and the corresponding sequence of 8-bit words may be entropy coded.

3. Dividing the N Point Clouds into Two Groups

As discussed above, using capturing device 112 and computing device 190, multi-sweep point clouds ψ={P₁, Ω₁, P₂, Ω₂, . . . , P_{N}, Ω_{N}} can be obtained. Each pair of a sensor pose Pₙ and a point cloud Ωₙ corresponds a particular location where the image used for generating the point cloud is captured. For example, a pair of a sensor pose P₁ and a point cloud Ω₂ may correspond to location 140 shown in FIG. 1.

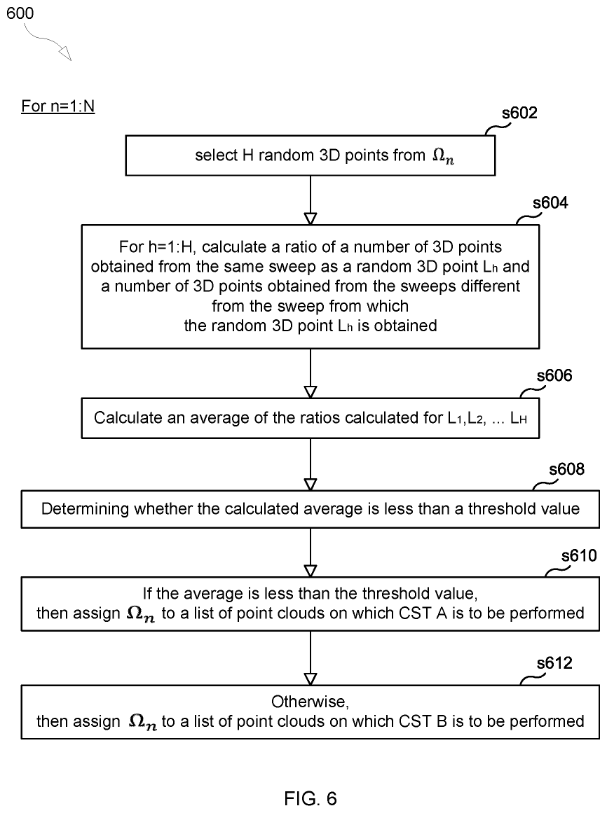

According to some embodiments, these point clouds ψ are divided into two groups—the first and second groups. The first group of the point clouds contains 3D points of which point data would be encoded in a stand-alone mode using CST A while the second group of the point clouds contains 3D points of which point data would be encoded as one large fused point cloud using CST B. A process 600 of dividing the N point clouds into the two groups is shown in FIG. 6. Process 600 comprises steps s602-s610. These steps may be performed for each Ωₙ included in the multi-sweep point clouds ψ. In other words, the steps s602-s610 may be performed in a loop for each Ωₙ (where n is an integer between 1 and N) where n=1:N. Process 600 may begin with step s602.

Step s602 comprises selecting a number (e.g., H) of random 3D points from Ωₙ. The number H (e.g., 1000) may be set depending on the complexity constraints. In some embodiments, instead of setting the number H, a percentage of the total number of 3D points included in Ωₙ may be used to indicate the number of random 3D points to be selected.

Step s604 comprises, for each space defined by each of the selected random 3D points (L₁, L₂, . . . , L_{H}), a ratio Rₕ of a number of the 3D points obtained from the same sweep as the selected random 3D point and a number of the 3D points obtained from the sweeps that are different from the sweep used for selecting the selected random 3D point is calculated.

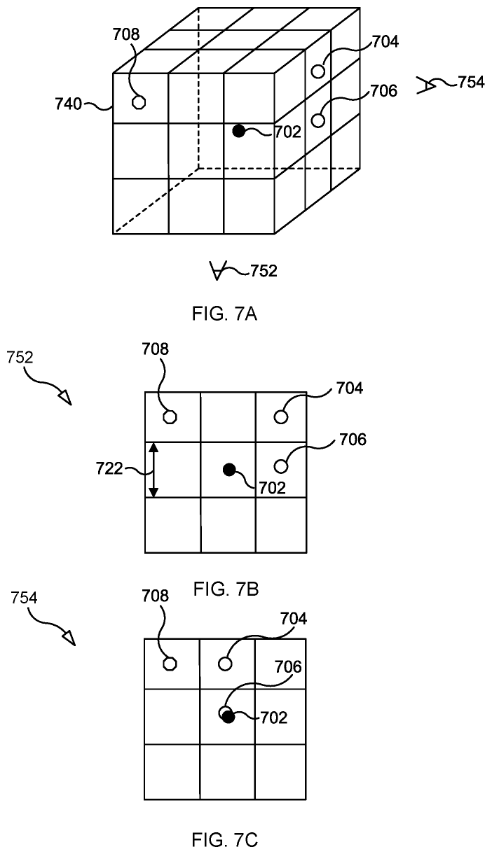

For example, let's assume that the random 3D points selected in step s602 comprises a 3D point 702 shown in FIG. 7A. In step s604, a space (e.g., a cube) 740 is defined with respect to the location of 3D point 702. More specifically, in FIG. 7A, cube 740 having a center at 3D point 702 is defined.

Cube 740 has a dimension of 3×3×3 voxels. An example of voxel 722 is shown in FIG. 7B. The number of voxels (e.g., 3) defining the dimension of cube 740 is shown in FIG. 7A for illustration purpose only, and does not limit the embodiments of this disclosure in any way.

In step s604, a number of 3D points obtained from the same sweep as the random 3D point 702 is determined. For example, in FIG. 7A, 3D points 702, 704, and 706 are obtained from the camera sweep performed at location 140 shown in FIG. 1 while 3D point 708 is obtained from the camera sweep performed at location 142. FIG. 7B shows a view 752 of cube 740 and FIG. 7C shows a view 754 of cube 740.

Then the ratio Rₕ is calculated. Here, the ratio Rₕ is 1 (corresponding to the 3D point 708)/2 (corresponding to the 3D points 704 and 706). Alternatively, the ratio Rₕ is 2 (corresponding to the 3D points 704 and 706)/1 (corresponding to the 3D point 708).

After calculating the ratios for each of the random 3D points selected in step s602, in step s606, an average of the calculated ratios is calculated. For example, the average ratio for the nth sweep may be equal to

$${\overline{R}}_{n} = \frac{1}{H} {\sum }_{h = 1}^{H} {R}_{h} ,$$

where Rₙ is the average ratio, Rₕ is the ratio for the sample 3D point Lₕ.

Step s608 comprises determining whether the average ratio is less than a threshold value (e.g., 0.5). If the average ratio is less than the threshold value (R̅ₙ<0), in step s610, the point cloud Ωₙ is assigned to a list of point clouds on which CST A is to be performed.

Otherwise (i.e., if the average ratio is not less than the threshold value), then in step s612, the point cloud Ωₙ is assigned to a list of point clouds on which CST B is to be performed.

### 4. Selectively Performing CST A or CST B on the Split Point Clouds

After performing process 600, at encoder 302, the point data of 3D points included in the first group is encoded using CST A while the point data of 3D points included in the second group is encoded using CST B. Similarly, at decoder 304, the encoded point data of 3D points included in the first group is decoded using a process that is reverse of the process of CST A and the encoded point data of 3D points included in the second group is decoded using a process that is reverse of the process of the CST B.

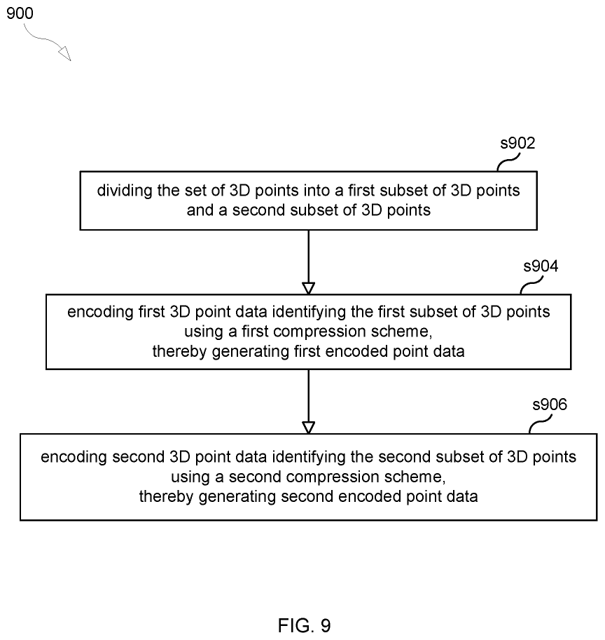

FIG. 9 shows a process 900 of encoding point data identifying a set of three-dimensional (3D) points. The set of 3D points corresponds to a set of physical points of a real-world environment. Process 900 may begin with step s902. Step s902 comprises dividing the set of 3D points into a first subset of 3D points and a second subset of 3D points. Step s904 comprises encoding first 3D point data identifying the first subset of 3D points using a first compression scheme, thereby generating first encoded point data. Step s906 comprises encoding second 3D point data identifying the second subset of 3D points using a second compression scheme, thereby generating second encoded point data. The first compression scheme and the second compression scheme are different.

In some embodiments, encoding the first 3D point data using the first compression scheme comprises: converting the first 3D point data into 2D point data corresponding to a range image containing a view of the real-world environment, wherein the range image comprises a plurality of pixels, and each pixel corresponds to a real-world point in the real-world environment; and encoding the 2D point data, thereby generating the first encoded point data.

In some embodiments, the 2D point data comprises a plurality of depth values mapped to the plurality of pixels, and a depth value mapped to a pixel indicates a distance between a reference point and a real-world point corresponding to the pixel.

In some embodiments, the second subset of 3D points includes a 3D point, and encoding the second 3D point data using the second compression scheme comprises: determining where the 3D point is located within a predefined volume; based on the determined location of the 3D point, generating a set of bits indicating where the 3D point is located within the predefined volume; and encoding the set of bits.

In some embodiments, a plurality of 3D blocks is defined within the predefined volume, a plurality of 3D sub-blocks is defined in each 3D block, and determining where the 3D point is located within the predefined volume comprises: a 3D block where the 3D point is included; and identifying a 3D sub-block where the 3D point is included, the identified 3D sub-block is included in the identified 3D block.

In some embodiments, the set of bits comprises a first subset of bits and a second subset of bits, the identified 3D block is mapped to the first subset of bits, the identified 3D sub-block is mapped to the second subset of bits.

In some embodiments, the second compression scheme is an octree-based coding.

In some embodiments, the set of 3D points includes a plurality of subsets of 3D points, and the method further comprises: evaluating a subset of 3D points included in the set of 3D points; based on the evaluation, determining whether to use the first compression technique or the second compression technique for encoding the evaluated subset of 3D points.

In some embodiments, evaluating the subset of 3D points comprises: selecting one or more 3D points included in the subset of 3D points; identifying 3D points that are within a predefined distance from each of said one or more 3D points; and for each of said one or more 3D points, evaluating the subset of 3D points based on the identified 3D points.

In some embodiments, identifying the 3D points that are within the predefined distance from each of said one or more 3D points comprises: determining, for each of said one or more 3D points, a first number of 3D points that are within the predefined distance from each of said one or more 3D points and that are obtained using one or more range images captured at a first location; and determining, for each of said one or more 3D points, a second number of 3D points that are within the predefined distance from each of said one or more 3D points and that are obtained using one or more range images captured at one or more locations that are different from the first location.

In some embodiments, evaluating the subset of 3D points comprises: for each of said one or more 3D points, determining a ratio of the first and second numbers; and evaluating the subset of 3D points based on the ratios.

In some embodiments, evaluating the subset of 3D points based on the ratios comprises evaluating the subset of 3D points based on an average of the ratios.

In some embodiments, evaluating the subset of 3D points comprises comparing the average to a threshold value, and whether to use the first compression technique or the second compression technique for encoding the evaluated subset of 3D points is determined based on the comparison.

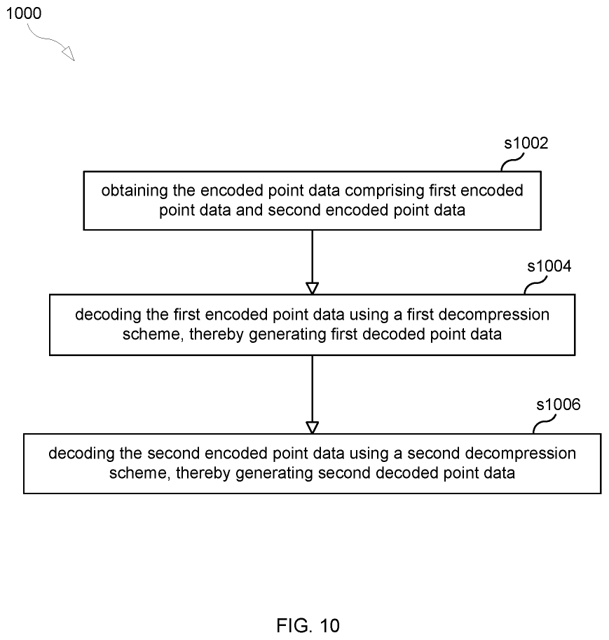

FIG. 10 shows a process 1000 of decoding encoded point data identifying set of three-dimensional (3D) points. The set of 3D points corresponds to a set of physical points of a real-world environment. Process 1000 may begin with step s1002. Step s1002 comprises obtaining the encoded point data comprising first encoded point data and second encoded point data, wherein the first encoded point data identifies a first subset of 3D points and the second encoded point data identifies a second subset of 3D points. Step s1004 comprises decoding the first encoded point data using a first decompression scheme, thereby generating first decoded point data. Step s1006 comprises decoding the second encoded point data using a second decompression scheme, thereby generating second decoded point data. The first compression scheme and the second compression scheme are different.

In some embodiments, the method comprises merging the first decoded point data and the second decoded point data, thereby generating 3D point data, wherein the generated 3D point data indicates coordinates of the set of 3D points within a 3D space.

In some embodiments, the method comprises receiving one or more bitstreams including the encoded point data that comprises the first encoded point data and the second encoded point data, wherein said one or more bitstreams further comprise a first value associated with the first encoded point data and a second value associated with the second encoded point data, the first value indicates the first decompression scheme, and the second value indicates the second decompression scheme.

In some embodiments, decoding the first encoded point data using the first decompression scheme comprises: converting 2D point data included in the first encoded point data into first 3D point data, wherein the 2D point data corresponds to a range image containing a view of the real-world environment, and further wherein the range image comprises a plurality of pixels, and each pixel corresponds to a real-world point in the real-world environment.

In some embodiments, the 2D point data comprises a plurality of depth values mapped to the plurality of pixels, and a depth value mapped to a pixel indicates a distance between a reference point and a real-world point corresponding to the pixel.

In some embodiments, the second subset of 3D points includes a 3D point, and decoding the second encoded point data using the second decompression scheme comprises: obtaining a set of bits indicating where the 3D point is located within a predefined volume; and determining a coordinate of the 3D point based on the set of bits, wherein the coordinate of the 3D point is defined in a 3D space.

In some embodiments, a plurality of 3D blocks is defined within the predefined volume, a plurality of 3D sub-blocks is defined in each 3D block, the set of bits identifies a 3D block where the 3D point is included and a 3D sub-block where the 3D point is included, and the identified 3D sub-block is included in the identified 3D block.

In some embodiments, the set of bits comprises a first subset of bits and a second subset of bits, the identified 3D block is mapped to the first subset of bits, the identified 3D sub-block is mapped to the second subset of bits.

In some embodiments, the second compression scheme is an octree-based coding.

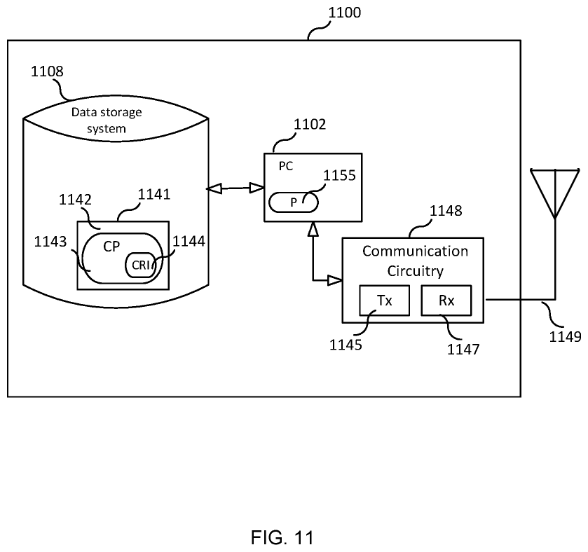

FIG. 11 shows an apparatus (e.g., a server, a mobile phone, a tablet, a laptop, a desktop, etc.) including encoder 302 and/or decoder 352. As shown in FIG. 11, the apparatus may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling the apparatus to transmit data and receive data (e.g., wirelessly transmit/receive data); and a local storage unit (a.k.a., “data storage system”) 1108, which may include one or more non-volatile storage devices and/or one or more volatile storage devices. In some embodiments, the apparatus may not include the antenna arrangement 1149 but instead may include a connection arrangement needed for sending and/or receiving data using a wired connection. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes the apparatus to perform steps described herein (e.g., steps described herein with reference to the flow charts). In other embodiments, the apparatus may be configured to perform steps described herein without the need for code. That is, for example, PC 1102 may consist merely of one or more ASICs. Hence, the features of the embodiments described herein may be implemented in hardware and/or software.

1.-29. (canceled)

30. A method of encoding point data identifying a set of points in a three-dimensional (3D) space (3D points), the set of 3D points corresponding to a set of physical points of a real-world environment, the method comprising:
dividing the set of 3D points into a plurality of subsets of 3D points;
selecting one or more 3D points included in a first subset of 3D points in the plurality of subsets of 3D points;
determining, for each of said one or more 3D points in the first subset, a first number of 3D points that are within a predefined distance from each of said one or more 3D points in the first subset and that are obtained using one or more range images captured at a first location;
determining, for each of said one or more 3D points in the first subset, a second number of 3D points that are within the predefined distance from each of said one or more 3D points in the first subset and that are obtained using one or more range images captured at one or more locations that are different from the first location;
for each of said one or more 3D points in the first subset, evaluating the first subset of 3D points based on the ratio of the first number of 3D points and the second number of 3D points;
based on the evaluation, determining whether to use a first compression scheme or a second, different, compression scheme for encoding the evaluated first subset of 3D points; and
encoding first 3D point data identifying the first subset of 3D points using the determined one of the first and second compression schemes, thereby generating first encoded point data.

31. The method of claim 30, further comprising encoding the first 3D point data using the first compression scheme, wherein encoding the first 3D point data using the first compression scheme comprises:
converting the first 3D point data into 2D point data corresponding to a range image containing a view of the real-world environment, wherein the range image comprises a plurality of pixels, and each pixel corresponds to a real-world point in the real-world environment; and
encoding the 2D point data, thereby generating the first encoded point data.

32. The method of claim 31, wherein
the 2D point data comprises a plurality of depth values mapped to the plurality of pixels, and
a depth value mapped to a pixel indicates a distance between a reference point and a real-world point corresponding to the pixel.

33. The method of claim 30, further comprising encoding the first 3D point data using the second compression scheme, wherein the first subset of 3D points includes a 3D point and encoding the first 3D point data using the second compression scheme comprises:
determining where the 3D point is located within a predefined volume;
based on the determined location of the 3D point, generating a set of bits indicating where the 3D point is located within the predefined volume; and
encoding the set of bits.

34. The method of claim 33, wherein
a plurality of 3D blocks is defined within the predefined volume,
a plurality of 3D sub-blocks is defined in each 3D block,
determining where the 3D point is located within the predefined volume comprises:
identifying a 3D block where the 3D point is included; and
identifying a 3D sub-block where the 3D point is included, and
the identified 3D sub-block is included in the identified 3D block.

35. The method of claim 34, wherein
the set of bits comprises a first subset of bits and a second subset of bits,
the identified 3D block is mapped to the first subset of bits, and
the identified 3D sub-block is mapped to the second subset of bits.

36. The method of claim 30, wherein the second compression scheme is an octree-based coding.

37. The method of claim 30, further comprising:
selecting one or more 3D points included in a second subset of 3D points in the plurality of subsets of 3D points;
determining, for each of said one or more 3D points in the second subset, a first number of 3D points that are within a predefined distance from each of said one or more 3D points in the second subset and that are obtained using one or more range images captured at a first location;
determining, for each of said one or more 3D points in the second subset, a second number of 3D points that are within the predefined distance from each of said one or more 3D points in the second subset and that are obtained using one or more range images captured at one or more locations that are different from the first location;
for each of said one or more 3D points in the second subset, evaluating the second subset of 3D points based on the ratio of the first number of 3D points and the second number of 3D points;
based on the evaluation, determining whether to use the first compression scheme or the second compression scheme for encoding the evaluated second subset of 3D points; and
encoding second 3D point data identifying the second subset of 3D points using the determined one of the first and second compression schemes, thereby generating second encoded point data.

38. The method of claim 37, further comprising encoding the first 3D point data identifying the first subset of 3D points using a determined one of the first and second compression schemes and encoding the second 3D point data identifying the second subset of 3D points using a different determined one of the first and second compression schemes.

39. The method of claim 30, further comprising:
evaluating the subset of 3D points based on the ratios by evaluating the subset of 3D points based on an average of the ratios.

40. The method of claim 39, further comprising:
evaluating the subset of 3D points by comparing the average to a threshold value; and
determining whether to use the first compression technique or the second compression technique for encoding the evaluated subset of 3D points based on the comparison.

41. A method of decoding encoded point data identifying a set of points in a three-dimensional (3D) space (3D points), the set of 3D points corresponding to a set of physical points of a real-world environment, the method comprising:
obtaining the encoded point data comprising first encoded point data and second encoded point data, wherein the first encoded point data identifies a first subset of 3D points encoded using a first compression scheme and the second encoded point data identifies a second subset of 3D points encoded using a second, different, compression scheme;
decoding the first encoded point data using a first decompression scheme, thereby generating first decoded point data; and
decoding the second encoded point data using a second decompression scheme, thereby generating second decoded point data, wherein
the first decompression scheme and the second compression scheme are different.

42. The method of claim 41, further comprising:
merging the first decoded point data and the second decoded point data, thereby generating 3D point data, wherein
the generated 3D point data indicates coordinates of the set of 3D points within a 3D space.

43. The method of claim 41, further comprising:
receiving one or more bitstreams including the encoded point data that comprises the first encoded point data and the second encoded point data, wherein
said one or more bitstreams further comprise a first value associated with the first encoded point data and a second value associated with the second encoded point data,
the first value indicates the first decompression scheme, and
the second value indicates the second decompression scheme.

44. The method of claim 41, wherein decoding the first encoded point data using the first decompression scheme comprises:
converting 2D point data included in the first encoded point data into first 3D point data, wherein the 2D point data corresponds to a range image containing a view of the real-world environment, and further wherein the range image comprises a plurality of pixels, and each pixel corresponds to a real-world point in the real-world environment.

45. The method of claim 44, wherein
the 2D point data comprises a plurality of depth values mapped to the plurality of pixels, and
a depth value mapped to a pixel indicates a distance between a reference point and a real-world point corresponding to the pixel.

46. The method of claim 41, wherein
the second subset of 3D points includes a 3D point, and
decoding the second encoded point data using the second decompression scheme comprises:
obtaining a set of bits indicating where the 3D point is located within a predefined volume; and
determining a coordinate of the 3D point based on the set of bits, wherein the coordinate of the 3D point is defined in a 3D space.

47. The method of claim 46, wherein
a plurality of 3D blocks is defined within the predefined volume,
a plurality of 3D sub-blocks is defined in each 3D block,
the set of bits identifies a 3D block where the 3D point is included and a 3D sub-block where the 3D point is included, and
the identified 3D sub-block is included in the identified 3D block.

48. The method of claim 47, wherein
the set of bits comprises a first subset of bits and a second subset of bits,
the identified 3D block is mapped to the first subset of bits,
the identified 3D sub-block is mapped to the second subset of bits.

49. The method of claim 41, wherein the second compression scheme is an octree-based coding.

50. A non-transitory computer readable storage medium storing a computer program comprising instructions which when executed by processing circuitry of an apparatus causes the apparatus to perform the method of claim 30.

51. An apparatus for encoding point data identifying a set of points in a three-dimensional (3D) space (3D points), the set of 3D points corresponding to a set of physical points of a real-world environment, the apparatus comprising:
a memory; and
processing circuitry coupled to the memory, wherein the apparatus is configured to:
divide the set of 3D points into a plurality of subsets of 3D points;
select one or more 3D points included in a first subset of 3D points in the plurality of subsets of 3D points;
determine, for each of said one or more 3D points in the first subset, a first number of 3D points that are within a predefined distance from each of said one or more 3D points in the first subset and that are obtained using one or more range images captured at a first location;
determine, for each of said one or more 3D points in the first subset, a second number of 3D points that are within the predefined distance from each of said one or more 3D points in the first subset and that are obtained using one or more range images captured at one or more locations that are different from the first location;
for each of said one or more 3D points in the first subset, evaluate the first subset of 3D points based on the ratio of the first number of 3D points and the second number of 3D points;
based on the evaluation, determine whether to use a first compression scheme or a second, different, compression scheme for encoding the first subset of 3D points; and
encode first 3D point data identifying the first subset of 3D points using the determined one of the first and second compression schemes, thereby generating first encoded point data.

52. An apparatus for decoding encoded point data identifying a set of points in a three-dimensional (3D) space (3D points), the set of 3D points corresponding to a set of physical points of a real-world environment, the apparatus comprising:
a memory; and
processing circuitry coupled to the memory, wherein the apparatus is configured to:
obtain the encoded point data comprising first encoded point data and second encoded point data, wherein the first encoded point data identifies a first subset of 3D points encoded using a first compression scheme and the second encoded point data identifies a second subset of 3D points encoded using a second, different, compression scheme;
decode the first encoded point data using a first decompression scheme, thereby generating first decoded point data; and
decode the second encoded point data using a second decompression scheme, thereby generating second decoded point data, wherein
the first decompression scheme and the second decompression scheme are different.

53. The apparatus of claim 52, wherein the apparatus is further configured to:
merge the first decoded point data and the second decoded point data, thereby generating 3D point data, wherein
the generated 3D point data indicates coordinates of the set of 3D points within a 3D space.

54. The apparatus of claim 52, wherein the apparatus is further configured to:
receive one or more bitstreams including the encoded point data that comprises the first encoded point data and the second encoded point data, wherein
said one or more bitstreams further comprise a first value associated with the first encoded point data and a second value associated with the second encoded point data,
the first value indicates the first decompression scheme, and
the second value indicates the second decompression scheme.

55. The apparatus of claim 52, wherein decoding the first encoded point data using the first decompression scheme comprises:
converting 2D point data included in the first encoded point data into first 3D point data, wherein the 2D point data corresponds to a range image containing a view of the real-world environment, and further wherein the range image comprises a plurality of pixels, and each pixel corresponds to a real-world point in the real-world environment.
